(19) United States
(12) Patent Application Publication
(10) Pub. No.: US 2022/0283017 A1
(43) Pub. Date: Sep. 8, 2022

(54) PORTABLE SCALE ASSEMBLY REMOVABLY ATTACHABLE TO A PORTABLE ELECTRONIC DEVICE

(71) Applicant: Trifecta, Inc., Sacramento, CA (US)

(72) Inventor: Greg Connolly, Davis, CA (US)

(21) Appl. No.: 17/653,616

(22) Filed: Mar. 4, 2022

Related U.S. Application Data
(60) Provisional application No. 63/158,029, filed on Mar. 8, 2021.

(51) Int. Cl. G01G 21/28; G01G 19/52

(52) U.S. Cl. CPC G01G 21/28; G01G 19/52; H04B 1/0346

(57) ABSTRACT

A portable electronic device accessory that includes a scale assembly that is removable attachable to the portable electronic device. The scale assembly may be integral with a case assembly or may be separate for a case assembly. The scale assembly includes a scale and a platform. The scale is removable attachable to the platform in a locked or attached configuration or a detached configuration. The scale is configured to weigh objects and transmit or communicate weight data to the portable electronic device so that the number of calories may be calculated, tracked, and stored by the portable electronic device.

### RELATED APPLICATIONS

This application claims priority to U.S. Provisional Application No. 63/158,029, filed on Mar. 8, 2021 and titled, “PORTABLE SCALE ASSEMBLY REMOVABLY ATTACHABLE TO A PORTABLE ELECTRONIC DEVICE,” which is hereby incorporated by reference in its entirety.

### TECHNICAL FIELD

The present disclosure relates generally to the field of accessories for portable electronic devices. More particularly, some embodiments relate to scale that is removably attachable to a portable electronic device for weighing food to help a user track calories.

### BRIEF DESCRIPTION OF THE DRAWINGS

The written disclosure herein describes illustrative embodiments that are non-limiting and non-exhaustive. Reference is made to certain of such illustrative embodiments that are depicted in the figures, in which:

FIG. 1A is a rear perspective view of a case assembly for a portable electronic device with a portable scale assembly according to one embodiment of the present disclosure.

FIG. 1B is a front perspective view of the case assembly of FIG. 1A.

FIG. 2 is a cross-sectional view of a case assembly detached from a portable electronic device according to one embodiment of the present disclosure.

FIG. 3A is an exploded view of a case assembly and a scale in a detached configuration according to one embodiment of the present disclosure.

FIG. 3B is a bottom perspective view of a scale of FIG. 3B.

FIG. 3C is a side view of the scale of FIG. 3A detached from the case assembly and placed on a flat surface to weigh the contents on a plate.

FIG. 3D is an exploded view of the scale of FIG. 3A.

FIG. 4A illustrates a side view of a scale attached to a case assembly, with an expandable member in a collapsed configuration according to one embodiment of the present disclosure.

FIG. 4B illustrates the expandable member of FIG. 4A in a partially expanded configuration.

FIG. 4C illustrates the expandable member of FIG. 4A in a fully expanded configuration.

FIG. 5 illustrates a perspective view of a scale attached to a case assembly, with an expandable member in a fully expanded configuration according to one embodiment of the present disclosure.

FIG. 6 illustrates a cross-sectional view of a scale attached to a case assembly, with an expandable member in a fully expanded configuration according to one embodiment of the present disclosure.

FIG. 7 illustrates a scale assembly detached from a case assembly that houses a portable electronic device according to one embodiment of the present disclosure.

FIG. 8 illustrates a scale assembly with a scale detached from a platform of the scale assembly in a detached configuration according to one embodiment of the present disclosure.

FIG. 9 illustrates a perspective view of the scale assembly of FIG. 8 with the scale and the platform in a locked configuration or attached configuration.

### DETAILED DESCRIPTION

The components of the embodiments as generally described and illustrated in the figures herein can be arranged and designed in a wide variety of different configurations. Thus, the following more detailed description of various embodiments, as represented in the figures, is not intended to limit the scope of the present disclosure, but is merely representative of various embodiments. While various aspects of the embodiments are presented in drawings, the drawings are not necessarily drawn to scale unless specifically indicated.

The phrase “coupled to” is broad enough to refer to any suitable coupling or other form of interaction between two or more entities, including mechanical interaction. Thus, two components may be coupled to each other even though they are not in direct contact with each other. The phrases “attached to” or “attached directly to” refer to interaction between two or more entities which are in direct contact with each other and/or are separated from each other only by a fastener of any suitable variety (e.g., mounting hardware or an adhesive).

Those trying to lose weight often track the number of calories that they consume during the day. The goal is to consume less calories than calories that are burned through exercise and daily body maintenance. Having a deficit of calories in a day is linked to weight loss. On the other hand, body builders and some athletes desire to gain muscle. Thus, they try to eat more calories than they burn during a day. The excess calories are believed to contribute to muscle gain when an individual executes appropriate workouts.

To track the number of calories eaten in a day, a user often looks at labels on food packaging to determine the amount of food that he or she can eat. If no caloric information is listed on the food packaging, the user may search the internet or look at publications to determine or estimate the number of calories in the food that he or she is eating.

Oftentimes, a user will use a scale to weigh food to calculate the number of calories a certain type of food may provide. While at home, the user may have access to a kitchen scale to weigh food. However, most kitchen scales are not practical for use outside the home. A typical kitchen scale would not be practical for a user to take to a restaurant or a friend's house to weigh his or her food before consuming. Therefore, a scale that would be easily portable may be advantageous to users that are looking to weigh their food before consuming in locations where taking a scale may not be practical. The portability of the scale would also enable the users to use the scale in their own home as well. In addition, a scale that could pair with the user's portable electronic device would make it easier for the user to remember to take the scale with him or her when he or she eats out of the house and track the calories consumed.

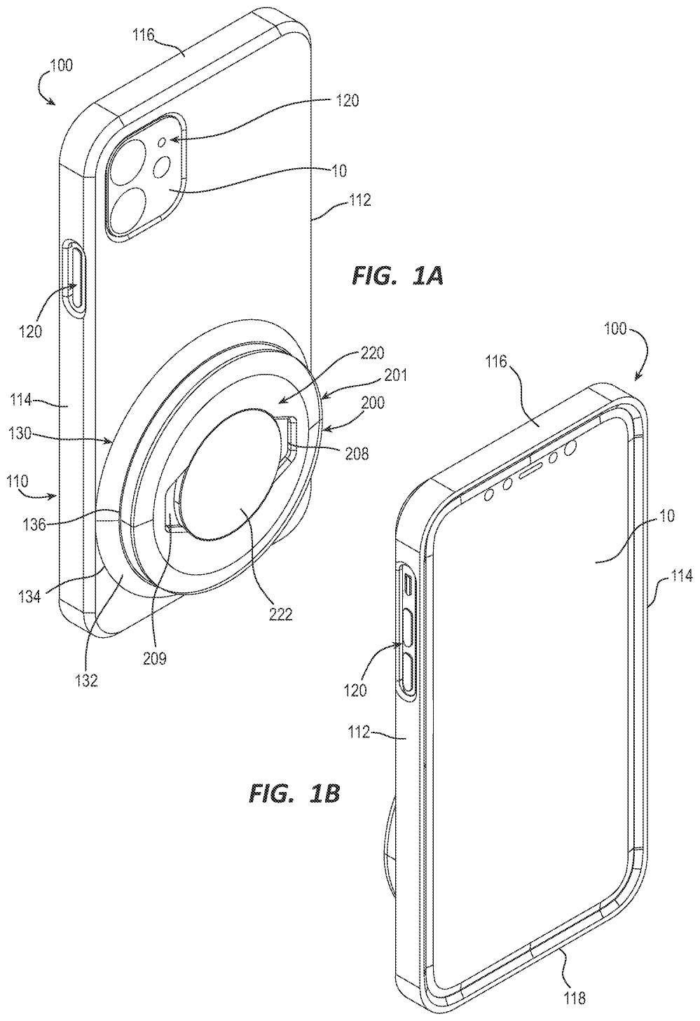

FIGS. 1A and 1B illustrate an accessory for a portable electronic device 10. The accessory is a case assembly 100 that houses and protects the portable electronic device 10. The case assembly 100 is removably attachable to the portable electronic device 10. In the illustrated embodiment, the portable electronic device 10 is a smart phone. The case assembly 100 may be customized to attach to a number of different types, sizes, and brands of smart phones. The case assembly 100 may also be customized to fit a plurality of different types of portable electronic devices, such as cellular phones, tablets, laptops, portable digital assistants, audio players, personal electronic devices, or combinations thereof.

The case assembly 100 comprises a back wall 110, a first sidewall 112 transversely connected to the back wall 110, and a second sidewall 114 transversely connected to the back wall 110 opposite the first sidewall 112. The case assembly 100 further comprises a top wall 116 transversely connected to the back wall 110 and a bottom wall 118 transversely connected to the back wall 110 and opposite the top wall 116.

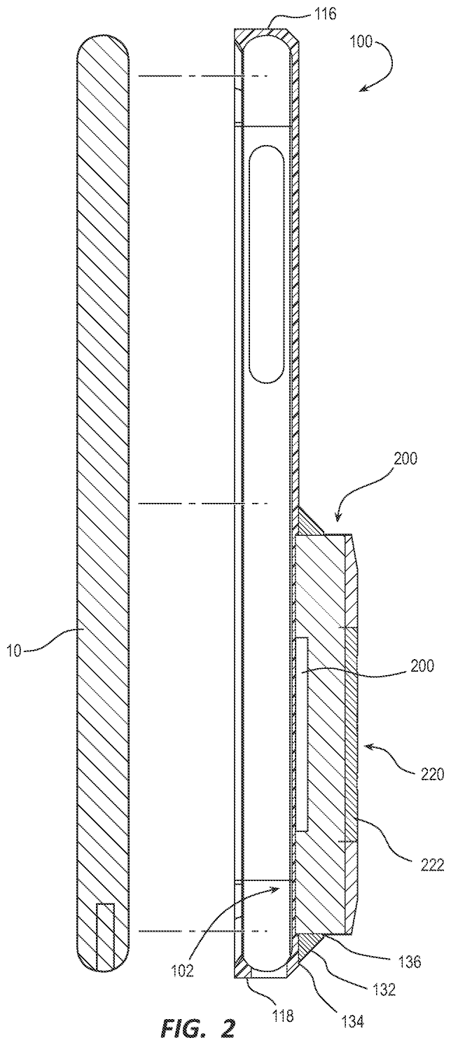

FIG. 2 illustrates a cross-sectional view of the case assembly 100 and the portable electronic device 10. The case assembly 100 comprises a portable electronic device receiving portion 102 that is configured to receive and partially enclose the portable electronic device 10. The walls 112, 114, 116, 118 are designed to hold the portable electronic device 10 in the portable electronic device receiving portion 102. The walls 112, 114, 116, 118 may be designed to overlap an outer edge of the portable electronic device 10 and may be slightly flexible to allow the walls 112, 114, 116, 118 to flex outward as the portable electronic device 10 is inserted into the portable electronic device receiving portion 102 and flex inward after the portable electronic device 10 is inserted into the portable electronic device receiving portion 102, thus securing the case assembly 100 to the portable electronic device 10.

The case assembly 100 may further comprise a plurality of ports or openings 120 for various components of the portable electronic device 10 to allow a user to access the components. For example, the case assembly 100 may include openings 120 for a camera, on-off switch, volume switch, power cord/headphone port, and the like.

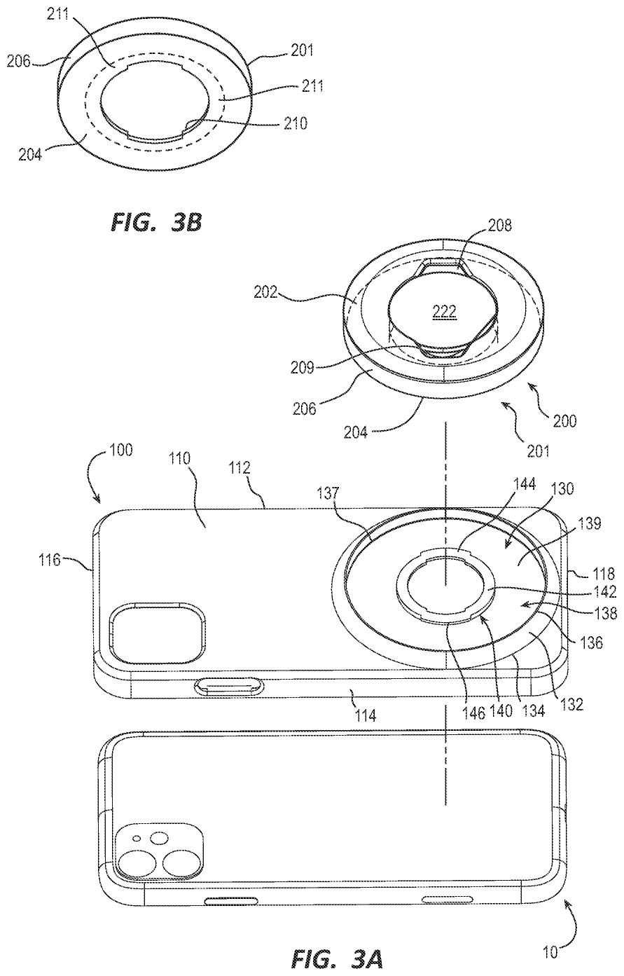

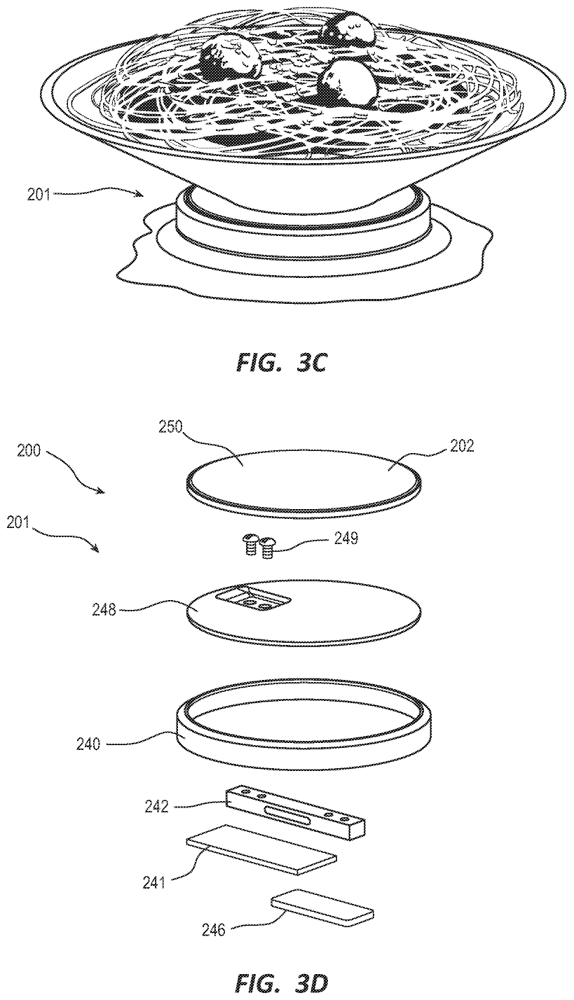

FIG. 3A illustrates an exploded view of the case assembly 100 and a scale assembly 200. The scale assembly 200 is removably attachable to the case assembly 100. FIG. 3A illustrates the scale assembly 200 in a detached configuration in which the scale assembly 200 in not attached to the case assembly 100. FIG. 1A illustrates the scale assembly 200 and the case assembly 100 in a locked or attached configuration, in which the scale assembly 200 is coupled to and secured to the case assembly 100.

The scale assembly 200 comprises a scale 201 that is configured to weigh objects. In some embodiments, the scale assembly 200 is configured to weigh objects only when the scale assembly 200 is detached from the case assembly 100. In some embodiments, the scale assembly 200 is configured to weigh objects when the scale assembly 200 is in the locked configuration or when the scale assembly 200 is in the detached configuration.

In the illustrated embodiment, the scale assembly 200 has a cylindrical shape. However, the scale assembly 200 is not so limited and may have a number of different shapes, such as cubic, cuboid, ovoid, and the like.

FIG. 3A illustrates an exploded view of the portable electronic device 10, the case assembly 100, and the scale assembly 200. The illustrated embodiment of FIG. 3A illustrates a top perspective view of the scale assembly 200. FIG. 3B illustrates a bottom perspective view of the scale assembly 200. The scale assembly 200 comprises a first surface 202, a second surface 204 opposite the first surface 202, and a sidewall 206. The first surface 202 and the second surface 204 have a substantially flat surface. The substantially flat surface of the second surface 204 of the scale assembly 200 allows the user to place the scale assembly 200 on a flat surface in order to weigh objects. In this configuration, the second surface 204 acts as a bottom surface and the first surface 202 may act as a top surface.

The substantially flat surface of the first surface 202 allows the user to place objects on the first surface 202 when the scale assembly 200 is placed on a flat surface. In this configuration, the first surface 202 acts as a top surface 202. FIG. 3C illustrates a plate placed on the first surface 202 of the scale assembly 200. The user is able to weigh a plate of food on the scale assembly 200 to help determine the number of calories of the plate of food.

FIG. 3D illustrates an exploded view of the scale 201. The scale 201 comprises a housing 240 to house the components of the scale 201. The housing 240 may be fabricated from any suitable material, such as plastics, polymers, metals, and the like. The scale 201 may further comprise a load cell 242. The load cell 242 may be a force transducer that may convert a force such as tension, compression, pressure, or torque into an electrical signal that can be measured. As the force applied to the load cell 242 increases, the electrical signal changes proportionally, thus enabling the load cell 242 to weigh different objects placed on top of the first surface 202 of the scale 201. The scale 201 may further comprise a printed circuit board 244 with a processor that is able to take the electrical signals from the load cell 242 and convert them into a weight.

The printed circuit board 244 may further comprise a transmitter to transmit or communicate the weight data to the portable electronic device 10. The user may detach the scale 201 from a platform 130 of the case assembly 100 and place the scale 201 on a flat surface, as illustrated in FIG. 3C, to weigh an object. The weight data obtained from the objects weight on the scale 201 may be transmitted to the portable electronic device 10 via a wireless network. The weight data may be stored in an application on the portable electronic device 10 so the number of calories in the food that is weighed may be calculated. The number of calories may be calculated, tracked, and stored in the portable electronic device 10. In some embodiments, the scale 201 may pair with the portable electronic device 10 through a pairing protocol, such as Bluetooth®.

The scale 201 may further comprise a power supply 246, such as a battery. Examples of the power supply 246 may include lithium batteries, supercapacitor, and the like. The power supply 246 is configured to power the components of the scale 201, such as the processor and the load cell 242. The power supply 246 may be a rechargeable battery that may be recharged via any suitable charging method, such as inductive charging or conductive charging.

The scale 201 may further comprise a scale cover 250, which may correspond with the first surface 202 of the scale 201. In some embodiments, the scale 201 may further comprise a plate 248, such as a metal plate that is disposed between the scale cover 250 and the load cell 242. The plate 248 may be secured to the load cell via fasteners 249.

Referring back to FIG. 3A, the case assembly 100 the platform 130 may be integral with the back wall 110 of the case assembly 100. In the illustrated embodiment, the platform 130 is disposed near the bottom wall 118. The platform 130 may extend substantially between the first sidewall 112 and the second sidewall 114. The platform 130 may be disposed in various different locations on the back wall 110. For example, the platform 130 may be centered on the back wall 110. When the scale 201 is coupled to the platform 130, if the user lays the case assembly 100 on a flat surface, the scale 201 balances the case assembly 100 so that only the scale 201 touches the flat surface and prevents the rest of the case assembly 100 from touching the flat surface.

In the illustrated embodiment, the platform 130 is circular for receiving the cylindrically shaped scale 201. However, the platform 130 may have a number of different shapes to correspond with the shape of the scale 201.

The platform 130 further comprises an outer rim 132. The outer rim 132 may be slanted from a bottom edge 134 to an upper edge 136. The platform 130 comprises a scale receiving portion 138 that is configured to receive the scale 201. The scale receiving portion 138 has an interior surface 139 and interior sidewalls 137. In the illustrated embodiment, the interior sidewall 137 is a circular wall that extends upward from the interior surface 139 of the scale receiving portion 138. In some embodiments, the interior surface 139 is the same surface as the back wall 110. In some embodiments, the interior surface 139 is in a parallel plane to the back wall 110. When the scale 201 is placed in the scale receiving portion 138, the sidewalls 206 of the scale 201 fit flush against the interior sidewall 137 of the scale receiving portion 138.

The platform 130 comprises a locking mechanism 140 that is configured to secure or lock the scale 201 to the platform 130 of the case assembly 100. FIG. 1A illustrates the scale 201 and the case assembly 100 in a locked configuration. FIG. 3A illustrates the scale 201 and the case assembly 100 in a detached configuration. The locking mechanism 140 may be able to lock or secure the scale 201 to the platform 130 of the case assembly 100 in a number of different ways. In the illustrated embodiment, the locking mechanism 140 is disposed in the center of the scale receiving portion 138. The locking mechanism 140 includes a center portion 142 that projects upward from the interior surface 139 of the scale receiving portion 138 of the platform 130. The locking mechanism 140 may comprise a pair of projections 144 and 146 that extend outward from the center portion 142 with a gap between the projections 144 and 146 and the interior surface 139 of the scale receiving portion 138. In the illustrated embodiment, a first projection 144 extends radially in a first direction toward the first sidewall 112 of the case assembly 100 and a second projection 146 that extends radially in a second direction toward the second sidewall 114 of the case assembly 100.

The second surface 204 of the scale 201, as illustrated in FIG. 3B, may comprise a recessed portion 210 for receiving the locking mechanism 140. A user may couple the scale 201 to the platform 130 by aligning the recessed portion 210 of the scale 201 with the locking mechanism 140. When the recessed portion 210 and locking mechanism 140 are aligned, the user may rotate the scale 201, and the first projection 144 and the second projection 146 may slide in grooves 211 in the recessed portion 210 that are configured to receive the projections 144 and 146.

Accordingly, rotation of the scale 201 relative to the locking mechanism 140 couples the scale 201 to the platform 130 to lock or secure the scale 201 to the case assembly 100. In other words, relative rotation of the scale 201 to the scale receiving portion 138 of the platform 130 secures or locks the scale 201 to the platform 130. Relative rotation of the scale 201 to the scale receiving portion 138 of the platform 130 detaches the scale 201 from the platform 130.

In some embodiments, clockwise rotation of the scale 201 relative to the case assembly 100 is configured to lock or secure the scale 201 to the case assembly 100. In some embodiments, counterclockwise rotation of the scale 201 relative to the case assembly 100 is configured to lock or secure the scale 201 to the case assembly 100. In some embodiments, clockwise or counterclockwise rotation of the scale 201 relative to the case assembly 100 is configured to lock or secure the scale 201 to the case assembly 100.

In some embodiments, when the scale 201 is in the locked configuration relative to the platform 130, the scale 201 may enter a partially disabled state. In the partially disabled state, the scale 201 does not function as a scale and does not transmit any data to the portable electronic device 10. In the partially disabled state, the scale 201 uses much less power, and therefore the power consumption of the scale 201 is greatly reduced, thus enabling the scale 201 to conserve power from the power supply 246 and letting the scale 201 have a longer battery life.

To unlock or detach the scale 201 from the case assembly 100, the user may rotate the scale 201 relative to the case assembly 100 until the recessed portion 210 of the scale 201 aligns with locking mechanism 140 and the user is able to detach the scale 201 from the case assembly 100. In some embodiments, clockwise rotation of the scale 201 relative to the case assembly 100 is configured to unlock the scale 201 from the case assembly 100. In some embodiments, counterclockwise rotation of the scale 201 relative to the case assembly 100 is configured to unlock the scale 201 to the case assembly 100. In some embodiments, clockwise or counterclockwise rotation of the scale 201 relative to the case assembly 100 is configured to unlock the scale 201 to the case assembly 100.

In some embodiments, when the scale 201 is unlocked from the platform 130, the scale 201 enters a fully enabled state, enabling the user to use the scale 201 to weigh objects, such as food, and transmit weight data to the portable electronic device 10. In this state, the scale 201 uses a lot more power than in the partially disabled state.

In some embodiments, the height of the sidewall 206 of the scale 201 is greater than the height of the outer rim 132 of the platform 130. Accordingly, a portion of the sidewall 206 extends higher than the upper edge 136 of the outer rim 132 when the scale 201 is received in the scale receiving portion 138. The user may grip the portion of the sidewall 206 that is exposed to grip the scale 201 to be able to rotate the scale 201 to lock and unlock the scale 201 to the case assembly 100.

In some embodiments, the height of the sidewall 206 of the scale 201 is the same as the height of the outer rim 132 of the platform 130. Accordingly, the first surface 202 of the scale 201 is flush with the upper edge 136 of the outer rim 132 when the scale 201 is locked to the case assembly 100. Accordingly, the outer rim 132 may comprise a plurality of cut-out portions (not shown) that enable the user to grip the scale 201 at the cut-out portions to enable the user to lock and unlock the scale 201 to the case assembly 100.

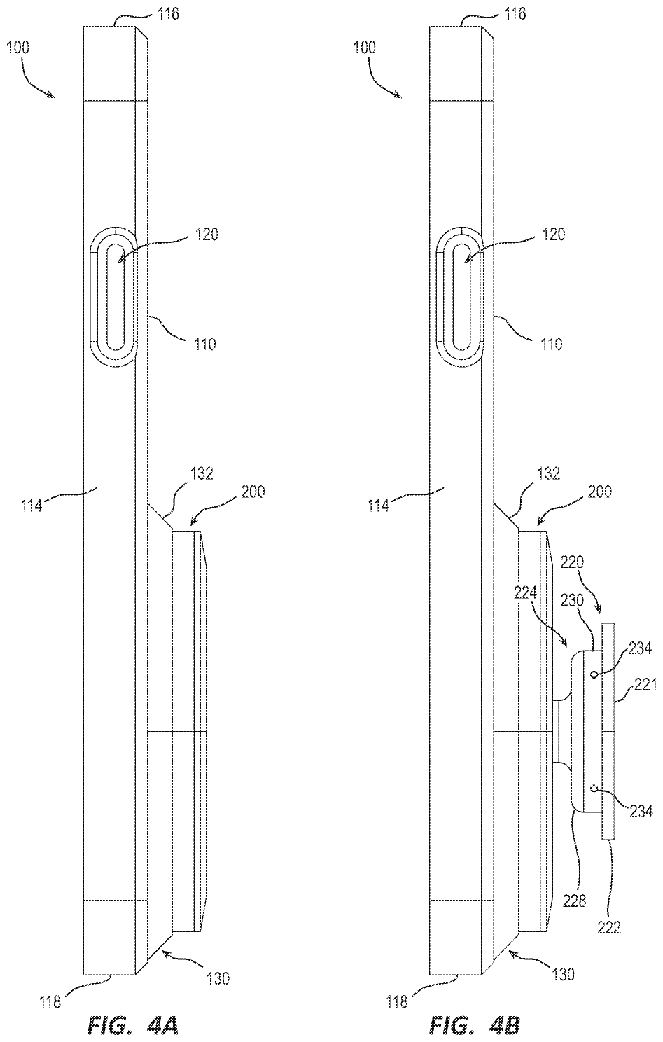

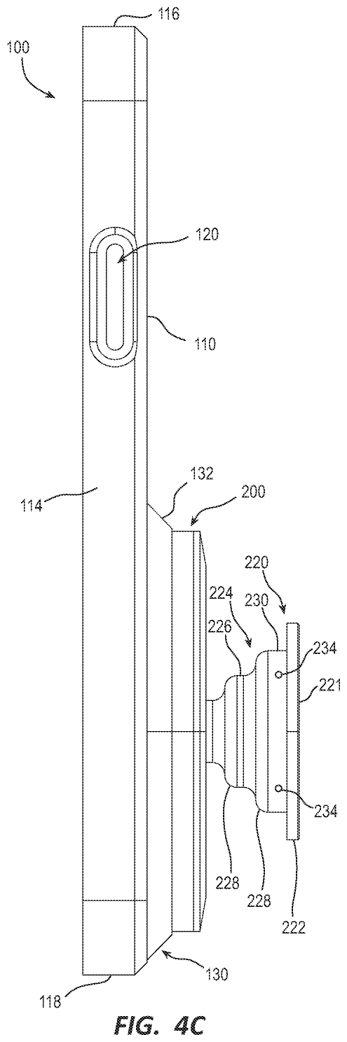

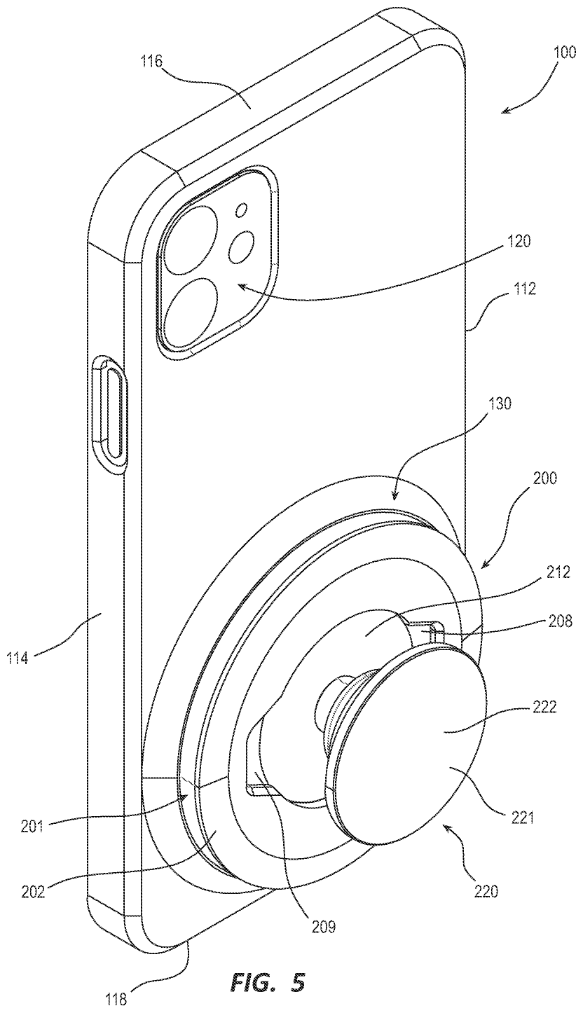

The scale 201 may further comprise an expandable member 220 that is configured to expand away from the first surface 202 of the scale 201. FIG. 4A illustrates the expandable member 220 in a collapsed configuration, FIG. 4B illustrates the expandable member 220 in a partially expanded configuration, and FIG. 4C illustrates the expandable member in a fully expanded configuration. While FIGS. 4A-4C only illustrate the expandable member 220 in two expandable configurations, the present disclosure is not so limited. The expandable member 220 may be expanded to more or less than two distinct expandable configurations, such as a plurality of intermediary expanded configurations, each extending the expandable member 220 a predetermined distance away from the top surface 202 of the scale 201. The illustrated embodiment of the expandable member 220 is configured to expand to at least three distinct expandable configurations. In other words, the expandable member 220 is movable between a collapsed configuration and an expandable configuration.

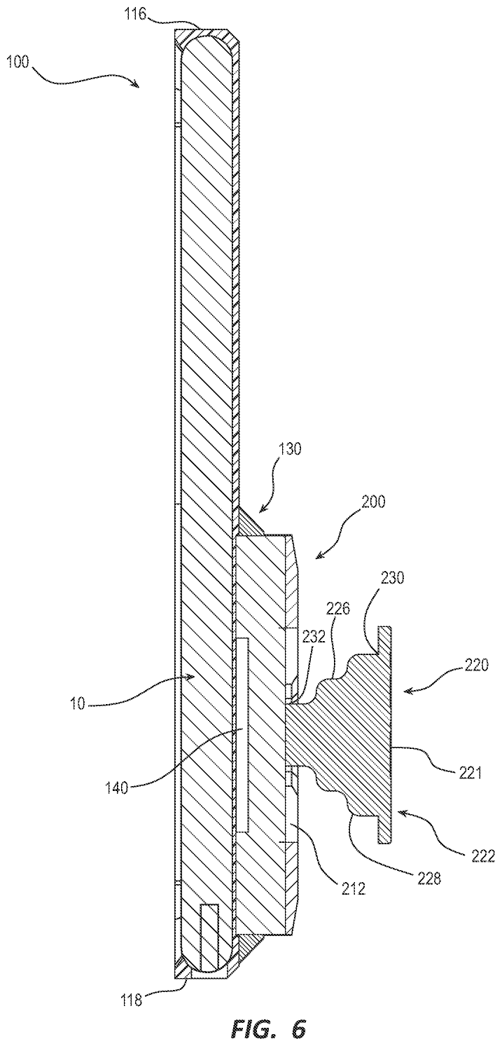

FIG. 5 illustrates a perspective view of the expandable member 220 in a fully expanded configuration. FIG. 6 illustrates a cross-sectional view of the expandable member 220 in a fully expanded configuration.

The expandable member 220 provides a number of benefits for the user. For example, in the fully expanded configuration or in the partially expanded configuration, the expandable member 220 enables the user to better grip the case assembly 100. For example, the user may place the expandable member 220 between his or her fingers to better grip the case assembly 100. This may enable to user to better grip the case assembly 100 when taking a picture, texting, and the like.

The expandable member 220 may enable a user to wrap a cord, such as a headphone cord, around the expandable member 220 when the expandable member 220 is in the fully expanded configuration or in the partially expanded configuration.

The expandable member 220 may enable the user to tilt his or her portable electronic device 10 at an angle when the expandable member 220 is in the fully expanded configuration or in the partially expanded configuration. The expandable member 220 balances the portable electronic device 10 so that is stays at the angle. The user may then view media on his or her portable electronic device 10 or make a video call.

The expandable member 220 may comprise a button 222 and a body 224. The button 222 may be a flat disc. In the collapsed configuration, a first surface 221 of the button 222 is coplanar with the first surface 202 of the scale 201.

The body 224 of the expandable member 220 enables the expandable member 220 to transition from the collapsed configuration to the partially expanded configuration and the fully expanded configuration. The body 224 takes the form of an accordion-like structure made of a deformable and durable material. The accordion-like structure of the body 224 includes a folding portion 226 that includes a plurality of relatively rigid walls interspersed with flexural hinges 228. The folding portion 226 is disposed between a first end 230 and a second end 232 of the body 224 and is symmetrical about a longitudinal axis of the body 224. A plurality of vents 234 are formed through the folding portion 226 of the body 224 to facilitate collapsing the expanding of the body 224 between the collapsed configuration, the partially expanded configuration, and the fully expanded configuration. The vents enable air to escape when the expandable member 220 is collapsed.

The expandable member 220 in the collapsed configuration is received in an expandable member receiving portion 212. The expandable member receiving portion 212 is recessed into the first surface 202 of the scale 201. The expandable member receiving portion 212 is configured to house the button 222 and the body 224 in the collapsed configuration with the first surface 221 of the button 222 coplanar with the first surface 202 of the scale 201.

In some embodiments, the first end 230 of the body 224 is removably attachable to the button 222. In some embodiments, the second end 232 of the body 224 is removably attachable to the expandable member receiving portion 212.

The first surface 202 of the scale 201 may further comprise a pair of slots 208 and 209 disposed on opposing sides of the button 222. The slots 208 and 209 may be recessed into the first surface 202 of the scale 201 to enable a user to grip the button 222 and expand the expandable member 220 from the collapsed configuration to a partially expanded or fully expanded configuration. The pair of slots 208 and 209 may extend laterally outward from the button 222 and have a depth equal to the depth of the button 222. In the illustrated embodiment of FIGS. 1A and 5, the first slot 208 extends radially outward in a first direction toward the first sidewall 112 of the case assembly 100 and the second slot 209 extends radially outward in a second direction toward the second sidewall 114 of the case assembly 100.

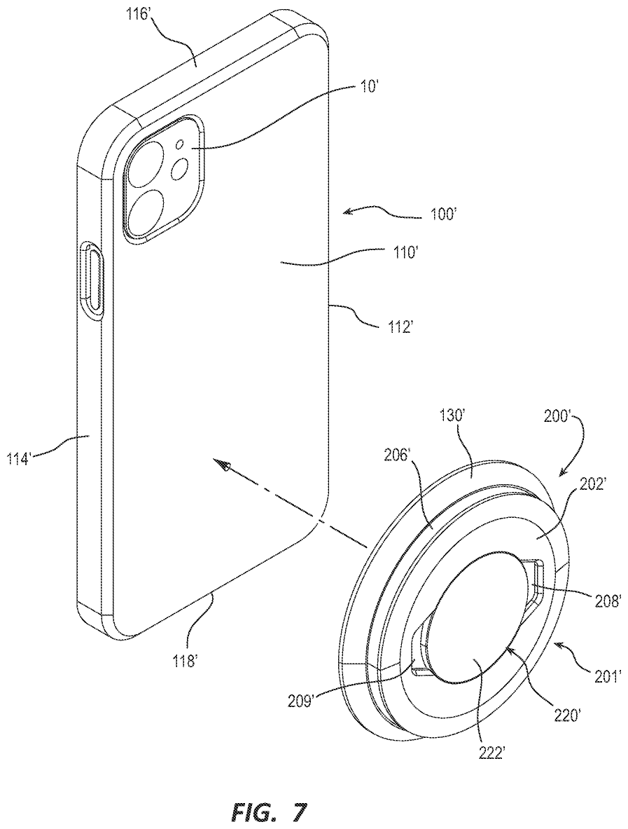

FIGS. 7-9 depict an embodiment of a case assembly 100′ and a scale assembly 200′ that resembles the case assembly 100 and the scale assembly 200 described above in certain respects. Accordingly, like features are designated with like reference numerals, with the reference number including an apostrophe. Relevant disclosures set forth above regarding similarly identified features thus may not be repeated hereafter. Moreover, specific features of the case assembly 100′ and the scale assembly 200′ and related components shown in FIGS. 1-6 may not be shown or identified by a reference numeral in the drawings or specifically discussed in the written description that follows. However, such features may clearly be the same, or substantially the same, as features depicted in other embodiments and/or described with respect to such embodiments. Accordingly, the relevant descriptions of such features apply equally to the features of the case assembly 100′ and the scale assembly 200′ and related components depicted in FIGS. 7-9. Any suitable combination of the features, and variations of the same, described with respect to the case assembly 100 and the scale assembly 200 and related components illustrated in FIGS. 1-6 can be employed with the case assembly 100′ and the scale assembly 200′ and related components of FIGS. 7-9, and vice versa.

FIG. 7 illustrates the case assembly 100′ for a portable electronic device 10′. In the illustrated embodiment, the portable electronic device 10′ is a smart phone. The case assembly 100′ may be customized to attach to a number of different types, sizes, and brands of smart phones.

The case assembly 100′ comprises a back wall 110′, a first sidewall 112′ transversely connected to the back wall 110′, and a second sidewall 114′ transversely connected to the back wall 110′ opposite the first sidewall 112′. The case assembly 100′ further comprises a top wall 116′ transversely connected to the back wall 110′ and a bottom wall 118′ transversely connected to the back wall 110 and opposite the top wall 116′.

The scale assembly 200′ is removably attachable to the case assembly 100′. FIG. 7 illustrates the scale assembly 200′ currently detached from the case assembly 100′. The scale assembly 200′ is configured to attached directly to the case assembly 100′. The scale assembly 200′ may be attached to the case assembly 100′ in a number of different locations on the case assembly 100′. In some embodiments, the scale assembly 200′ is removably attachable to the portable electronic device 10′ instead of to the case assembly 100′.

FIG. 8 illustrates an exploded view of the scale assembly 200′. The scale assembly 200′ comprises a platform 130′ and the scale 201′, in contrast to the embodiment illustrated in FIG. 1A in which the platform 130 is integral with the case assembly 100. In the illustrated embodiment, the scale 201′ has a cylindrical shape. However, the scale 201′ is not so limited and may have a number of different shapes, such as cubic, cuboid, ovoid, and the like.

The scale 201′ comprises a first surface 202′, a second surface 204′ opposite the first surface 202′, and a sidewall 206′. The first surface 202′ and the second surface 204′ have a substantially flat surface. The substantially flat surface of the second surface 204′ of the scale 201′ allows the user to place the scale 201′ on a flat surface in order to weigh objects. In this configuration, the second surface 204′ acts as a bottom surface.

The platform 130′ of the scale assembly 200′ is configured to receive the scale 201′. When the scale 201′ is disposed in the platform 130′, the scale 201′ may be locked or secured to the platform 130′.

In the illustrated embodiment, the platform 130′ is circular for receiving the cylindrically shaped scale 201′. However, the platform 130′ may have a number of different shapes to correspond with the shape of the scale 201′.

The platform 130′ further comprises an outer rim 132′. The outer rim 132′ may be slanted from a bottom edge 134′ to an upper edge 136′. The platform 130′ comprises a scale receiving portion 138′ that is configured to receive the scale 201′. The scale receiving portion 138′ has an interior surface 139′ and interior sidewalls 137′. In the illustrated embodiment, the interior sidewall 137′ is a circular wall that extends upward from the interior surface 139′ of the scale receiving portion 138.' When the scale 201′ is placed in the scale receiving portion 138′, the sidewalls of 206′ of the scale 201′ fit flush against the interior sidewall 137′ of the scale receiving portion 138′.

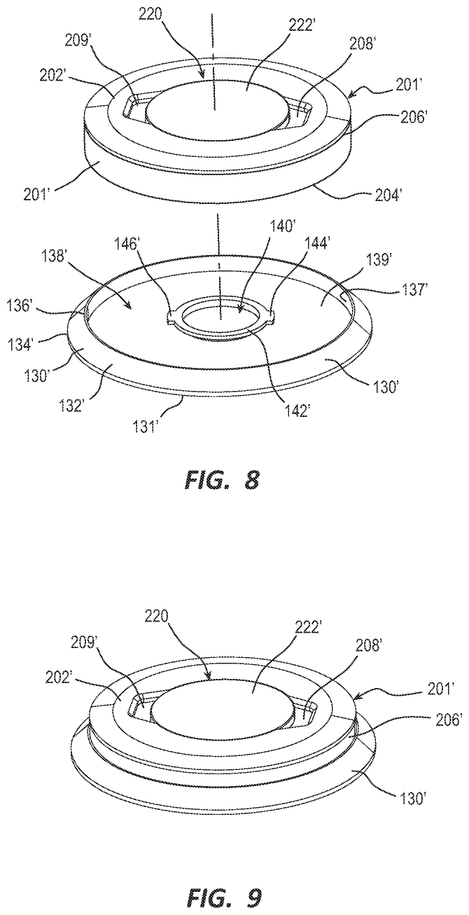

The platform 130′ comprises a locking mechanism 140′ that is configured to secure or lock the scale 201′ to the platform 130′. FIG. 8 illustrates the scale 201′ and the platform 130′ in a detached configuration. FIG. 9 illustrates the scale 201′ and the platform 130′ in a locked configuration. The locking mechanism 140′ may be able to lock or secure the scale 201′ to the platform 130′ in a number of different ways. In the illustrated embodiment, the locking mechanism 140′ is disposed in the center of the scale receiving portion 138′. The locking mechanism 140′ includes a center portion 142′ projected upward from the interior surface 139′ of the scale receiving portion 138′ of the platform 130′. The locking mechanism 140′ may comprise a pair of projections 144′ and 146′ that extend outward in opposite directions from the center portion 142′ with a gap between the projections 144′ and 146′ and the interior surface 139′ of the scale receiving portion 138′.

The second surface 204′ of the scale 201′ may comprise a recessed portion (not shown) with a corresponding shape to the locking mechanism 140′. The user may couple the scale 201′ to the platform 130′ by aligning the recessed portion of the scale 201′ with the locking mechanism 140′. When the recessed portion and locking mechanism 140′ are aligned, the user may rotate the scale 201′, and the first projection 144′ and the second projection 146′ may slide in grooves (not shown) in the recessed portion that are configured to receive the projections 144′ and 146′.

Accordingly, rotation of the scale 201′ relative to the locking mechanism 140′ couples the scale 201′ to the platform 130′ to lock or secure the scale 201′ to the platform 130′. To unlock or detach the scale 201′ from the platform 130′, the user may rotate the scale 201′ relative to the platform 130′ until the recessed portion of the scale 201′ aligns with the locking mechanism 140′ and the user is able to detach the scale 201′ from the platform 130′.

In some embodiments, the height of the sidewall 206′ of the scale 201′ is greater than the height of the outer rim 132′ of the platform 130′. Accordingly, a portion of the sidewall 206′ extends higher than the upper edge 136′ of the outer rim 132′ when the scale 201′ is received in the scale receiving portion 138′. The user may grip the portion of the sidewall 206′ that is exposed to grip the scale 201′ to be able to rotate the scale 201′ to lock and unlock the scale 201′ to the platform 130′.

The platform 130′ may further comprise an attachment surface 131′. The attachment surface 131′ is a bottom surface of the platform 130′ and may be substantially flat. The attachment surface 131′ may comprise an adhesive to facilitate attachment of the platform 130′ to the portable electronic device 10′ or the case assembly 100′. The adhesive is strong enough to attach the scale 201′ to the portable electronic device 10′ or the case assembly 100′, and strong enough to not be easily removed. However, the platform 130′ may be removed if a predetermined amount of force is applied to remove the platform 130′ from the portable electronic device 10′ or the case assembly 100′. If the platform 130′ is removed from the portable electronic device 10′ or the case assembly 100′, the adhesive is configured to reattach to the portable electronic device 10′ or the case assembly 100′.

The platform 130′ may be attached to various different locations on the back wall 110′ of the case assembly 100′ or the back surface of the portable electronic device 10′.

The scale 201′ may further comprise an expandable member 220′ that is configured to expand away from the first surface 202′ of the scale 201′. While not illustrated, the expandable member 220′ may expand similar to the expandable member 220 illustrated in FIGS. 4A-4C.

Any methods disclosed herein include one or more steps or actions for performing the described method. The method steps and/or actions may be interchanged with one another. In other words, unless a specific order of steps or actions is required for proper operation of the embodiment, the order and/or use of specific steps and/or actions may be modified. Moreover, sub-routines or only a portion of a method described herein may be a separate method within the scope of this disclosure. Stated otherwise, some methods may include only a portion of the steps described in a more detailed method.

Reference throughout this specification to “an embodiment” or “the embodiment” means that a particular feature, structure, or characteristic described in connection with that embodiment is included in at least one embodiment. Thus, the quoted phrases, or variations thereof, as recited throughout this specification are not necessarily all referring to the same embodiment.

Similarly, it should be appreciated by one of skill in the art with the benefit of this disclosure that in the above description of embodiments, various features are sometimes grouped together in a single embodiment, figure, or description thereof for the purpose of streamlining the disclosure. This method of disclosure, however, is not to be interpreted as reflecting an intention that any claim requires more features than those expressly recited in that claim. Rather, as the following claims reflect, inventive aspects lie in a combination of fewer than all features of any single foregoing disclosed embodiment. Thus, the claims following this Detailed Description are hereby expressly incorporated into this Detailed Description, with each claim standing on its own as a separate embodiment. This disclosure includes all permutations of the independent claims with their dependent claims.

Recitation in the claims of the term “first” with respect to a feature or element does not necessarily imply the existence of a second or additional such feature or element. It will be apparent to those having skill in the art that changes may be made to the details of the above-described embodiments without departing from the underlying principles of the present disclosure.

We claim:

1. A portable electronic device accessory comprising:
a platform;
a scale that is removably attachable to the platform, the scale comprising a load cell; and
a locking mechanism to secure the scale to the platform in a locked configuration and detach the scale from the platform in an unlocked configuration.

2. The portable electronic device accessory of claim 1, wherein the platform is removably attachable to a portable electronic device.

3. The portable electronic device accessory of claim 2, wherein the platform comprises a first surface, wherein the first surface is flat and comprises an adhesive to attach the platform to the portable electronic device.

4. The portable electronic device accessory of claim 1, wherein the platform is integral with a case body that attaches to a portable electronic device and partially encloses the portable electronic device.

5. The portable electronic device accessory of claim 1, wherein the platform comprises an outer rim and a receiving portion to receive the scale.

6. The portable electronic device accessory of claim 5, wherein in the locked configuration, the scale is disposed in the receiving portion and an upper edge of the outer rim is disposed below a top surface of the scale.

7. The portable electronic device accessory of claim 5, wherein rotation of the scale when the scale is in the receiving portion of the platform locks and/or unlocks the scale to the platform.

8. The portable electronic device accessory of claim 1, wherein when the scale comprises a bottom surface and a top surface, wherein the bottom surface is relatively flat to enable the bottom surface to be placed on a flat surface and the top surface is configured to receive an object to be weighted on the scale.

9. The portable electronic device accessory of claim 8, wherein the scale has a cylindrical shape.

10. The portable electronic device accessory of claim 8, wherein the scale further comprises an expandable member, wherein the expandable member is movable between an expanded configuration that extends away from the top surface of the scale and a collapsed configuration that is flush with the top surface of the scale.

11. The portable electronic device accessory of claim 10, wherein the expandable member comprises a plurality of distinct expandable configurations, wherein each distinct expandable configuration extends the expandable member to a predetermined distance away from the top surface of the scale.

12. The portable electronic device accessory of claim 11, wherein the expandable member further comprises:
a body with a first end and a second end, wherein the body is made of a deformable material with an accordion-like structure with the first end coupled to the scale; and
a button coupled to a second end of the scale, wherein a user may grip the button and extend the body and the button away from the scale to the plurality of distinct expandable configurations.

13. The portable electronic device accessory of claim 12, wherein the top surface of the scale comprises a pair of slots disposed on opposing sides of the button enabling the user to grip the button to extend the button away from the top surface of the scale.

14. The portable electronic device accessory of claim 1, wherein the scale comprises a transmitter to communicate with a portable electronic device and transmit weight data that is obtained from objects weighed on the scale.

15. A portable electronic device accessory comprising:
a scale comprising a load cell configured to weigh objects; and
a platform that is removably attachable to a portable electronic device or a case for the portable electronic device comprising:
an attachment surface;
an outer rim defining a scale receiving portion, wherein the scale receiving portion has a corresponding shape to the scale; and
a locking mechanism to secure the scale to the platform in the scale receiving portion in a locked configuration and detach the scale from the platform in an unlocked configuration.

16. The portable electronic device accessory of claim 15, wherein the scale further comprises an expandable member, wherein the expandable member is movable between an expanded configuration that extends away from a top surface of the scale and a collapsed configuration that is flush with the top surface of the scale.

17. The portable electronic device accessory of claim 15, wherein the locking mechanism comprises:
a center portion that is disposed in a center of the scale receiving portion and extends away from an interior surface of the scale receiving portion; and
a pair of projections that extend radially outward from the center portion with a gap between the pair of projections and the interior surface of the scale receiving portion,
wherein a bottom surface of the scale comprises a recessed portion with grooves to receive the pair of projections to lock the scale to the platform.

18. A portable electronic device accessory comprising:
a scale with a cylindrical shape comprising a load cell configured to weigh objects; and
a platform configured to receive the scale within a scale receiving portion of the platform,
wherein relative rotation of the scale to the scale receiving portion of the platform is configured to lock the scale to the platform and relative rotation of the scale to the scale receiving portion of the platform is configured to detach the scale from the platform.

19. The portable electronic device accessory of claim 18, wherein the relative rotation in a first direction locks to the scale to the platform and relative rotation in a second direction detaches the scale from the platform.

20. The portable electronic device of claim 18, wherein the platform is removably attachable to a portable electronic device or a case for the portable electronic device.
